(19) United States
(12) Patent Application Publication
(10) Pub. No.: US 2017/0367299 A1
(43) Pub. Date: Dec. 28, 2017

(54) NEURO-MUSCULAR REHABILITATION DEVICE FOR QUADRUPEDS AND EQUINES

(71) Applicants: JILL MCDERMOTT, BARK RIVER, MI (US); LYNDA REESE, ESCANABA, MI (US)

(72) Inventors: JILL MCDERMOTT, BARK RIVER, MI (US); LYNDA REESE, ESCANABA, MI (US)

(21) Appl. No.: 15/700,167

(22) Filed: Sep. 10, 2017

Related U.S. Application Data
(63) Continuation-in-part of application No. 14/314,944, filed on Jun. 25, 2014, now abandoned.

(51) Int. Cl. A01K 15/02; A01K 27/00; B68B 3/00

(52) U.S. Cl. CPC A01K 15/027; A01K 27/002; B68B 3/00

(57) ABSTRACT

A neuro-muscular rehabilitation device for quadruped animal, specifically canine and equine animal. Said device comprising elastic compression bands to be worn laterally around the length of the quadruped animal and around its midsection. The device providing mild compression upon the contacted muscle groups to facilitate tension force transfer between moving parts of the animal.

### CROSS REFERENCE TO RELATED APPLICATIONS

This Continuation-In-Part utility patent application claims priority benefit of and incorporates by reference the full and complete disclosure of the pending Nonprovisional Patent application Ser. No. 14/314,944, filed Jun. 25, 2014 which further having a priority date from Provisional Patent Application No. 61839357, originally filed on Jun. 25, 2013.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark office, patent file or records, but otherwise reserves all copyright rights whatsoever.

### BACKGROUND OF THE INVENTION

### Field of the Invention

A neuro-muscular rehabilitation device for muscle tone development and improvement of neuro-muscular coordination of quadruped animals, specifically canines and equines.

### Background

In the field of veterinary science, information on the topic of neuro-muscular development of equines at the cellular level is limited. Pierre A. Guertin, Central Pattern Generator for Locomotion: Anatomical, Physiological, and Pathophysiological Considerations, Front. Neurol., 3: 183 (2012). Much of the published information on the topic of muscular tone development and rehabilitation for equines focus on post-injury rehabilitation by way of physical therapy techniques, taking the approach of treating symptoms. A greater body of science relating to neuro-muscular function and development exists in the field of cellular biology and neuro-physiology. In these areas of study, a fundamental approach is taken with thorough comparative observations of neurophysiology among different species (human and cat) for causal understanding of muscular tone development. It would be in this area of study that greater insight can be gained over the cellular cause of poor postural symptoms observed among equines.

The Australian Journal of Physiotherapy published a very poignant article in 1983 entitled “The Neurophysiology of Tone: The Role of the Muscle Spindle and the Stretch Reflex” by Helen Cameron-Tucker regarding the cellular composition and development of muscle fiber in relation to external demands and intermuscular stimuli affecting muscle tone and function. Cameron-Tucker, Helen, The Neurophysiology of Tone: The Role of the Muscle Spindle and the Stretch Reflex, The Australian Journal of Physiotherapy, Vol. 29, No. 5, October 1983. This publication summarized the most current valid science of that time, which remains fundamental science today.

According to Cameron-Tucker and cited prior studies, muscular fibers comprise extended spindle features and core neurone features. The ends of each muscle spindle having neuro-synaptic sensitivity directly communicating with spinal grey matter and is individually sensitive as well as responsive to external stimuli. External stimuli in this context includes stimuli caused by intermuscular activity and usage, measured by locational quantity, quality and frequency of usage or demand. According to Cameron-Tucker in her discussion, the generation of muscle fiber tissue at an individual cellular level is in response to external stimulus and demand. Muscle spindle, having myogenetic capability (regenerating capability) is therefore dynamic and may adapt to new environmental demands as well as frequency of use by creating new muscle to suit external demand with either greater or lower ATP power. ATP power being positioned centrally within the muscle spindle. Muscle spindle positioning in fact, according to Eldred (1965) “is usually near an intramuscular nerve and artery . . . [t]his ‘in parallel’ arrangement means that the muscle spindle will be stretched at a similar rate and to a similar degree as the extrafusal fibers.” Cameron-Tucker, Helen, The Neurophysiology of Tone: The Role of the Muscle Spindle and the Stretch Reflex, The Australian Journal of Physiotherapy, Vol. 29, No. 5, p. 156, October 1983; Eldred, E., The dual sensory role of muscle spindles, Journal of the Americal Physical therapy Association, 45, 290-313 (1965). The strategic positioning of myogenic cells enables it to be sensitive to the realities of movement and external demand for timely muscle response, growth and tone development. Brodal (1962) “noted that muscle spindles are located in all the muscles of locomotion . . . muscles used in delicate movement such as the muscles of the hand have a greater density of muscle spindles than do muscles of the trunk . . . the muscle spindles of any of these muscles have a similar structure . . . ” Cameron-Tucker, Helen, The Neurophysiology of Tone: The Role of the Muscle Spindle and the Stretch Reflex, The Australian Journal of Physiotherapy, Vol. 29, No. 5, p. 156, October 1983; Brodal, A., Spasticity—Anatomical Aspects, Acta Neurologica Scandinavia, Supplement 3, 38, 9-40 (1962).

According to Matthews (1973) “Golgi tendon organs can be excited by single motor units and therefore may be excited by only the muscle fibres attaching to the tendon on which the organ lies and not by other fibres.” Cameron-Tucker, Helen, The Neurophysiology of Tone: The Role of the Muscle Spindle and the Stretch Reflex, The Australian Journal of Physiotherapy, Vol. 29, No. 5, p. 156, October 1983; Matthews P B C, The advances of the last decade of animal experimentation upon muscle spindles, in Desmedt J E (ed), New Developments in Electromygraphy and Clinical Neurophysiology, 3, 95-125, Karger, Basel (1973). The neuro-muscular sensitivity to isolated local stimuli is important to note, and may be a special condition to quadruped animals such as equines where the overlap of muscles between the fore-end and hind-end may be too distant, resulting in an area in the center of low intermuscular communication between the farther regions. As such, there is a likelihood that neuro-muscular communication would be regionally focused and local muscle interaction would create greater local stimuli, demand, and response for growth. In cases involving injured equines, avoidance of use over injured muscle regions may cause a communication blind spot with isolation and stagnation of muscle tone development around the injured area. Lack of use eventually resulting in muscles becoming deaf to the rest of its bodily activity. The lowered level of stimuli around the injured region may lead to decreased communication to muscle spindles around the injured area, resulting in eventual isolation, decreased muscle growth and disjointed posture and movement.

These scientific observations concur with current studies on proprioception among animals. Unlike other areas of animal physical therapy and training that focus on distinctive psychological or anatomical issues, the study of proprioception recognizes the interactive relationship between distinct senses in the horse's mind and body in relation to its external environment. It is distinguished from exteroception, by which one perceives the outside world, and interoception, by which one perceives the movement of internal organs such as sensing pain and hunger. “Proprioception” is an awareness of movement derived from muscular, tendon, and articular sources.

Proprioception is further distinguished from kinesthesia by the element of equilibrium or balance. The animal's proprioceptive awareness of its surrounding environment involves the combination of neurological senses that assist the body's various muscle and tendon groups to coordinate in a subconscious level to move in a proper fluid manner. Unlike kinesthesia which focuses on the body's motion or movement, proprioception focuses on the body's awareness of its own movement and behaviors. Poor proprioception may be due to a chronic imbalance in posture from prior injury or simply poor habit. In these circumstances, the chronic regions become isolated and less aware of the rest of the body.

Prior art devices relating to equine training and therapy fail to address neuro-muscular sensitivity and coordination at a cellular level. The method introduced by TTEAM company with its Tellington TTouch body wrap provides a loose length of fabric tied to the base of the horse's neck connected a second bandage connected around the rear of the horse's body. A quick release knot connecting the two bandages is located above the back of the animal, creating a sense of lift at the base of the horse's neck and the horse's lower hindquarter. This device takes a symptomatic approach to improving the animal's behavior in terms of its sense of secureness and confidence in relation to the rider by a swaddling effect. It would not have been easily understood by technicians in the field of equine physical rehabilitation the neuro-cellular interactions of skeletal muscle spindle cells as these are vastly different areas of expertise. As such, the TTEAM device and method is limited to treatment of the symptom rather than the cause of the problem.

Similarly, U.S. Pat. No. 6,612,265 does not facilitate regional muscular communication. Rather, the device functions as a training lead, restricting movement and causing further miscommunication between muscle regions.

U.S. Pat. No. 7,963,256 provides motion control for dog training. The device is self-restricting, wherein the animal becomes constricted when moving beyond the release of the straps. The device serves as a halter, creating unnatural external stimulus.

There remains a need in this field of art for a device and method that provides rehabilitative treatment muscle and postural issues among quadruped from a causal approach. Particularly, relating to neuro-physiology and skeletal muscle cell development, a means for improving neuro-communication between regional muscle groups to maintain continued intermuscular activity despite injury.

All patents and applications referred herein are incorporated by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

### SUMMARY OF INVENTION

The invention herein provides a conduit for communication between distant regions of muscle mass of a quadruped, specifically an equine. The device comprising an elastic band that is laterally positioned around the horizontal length of the quadruped, extending around the fore-end and hind-end through the midsection. The device having a width sufficient to contact various muscle groups of the front quarter, hindquarter and midsection along a lateral path, particularly contacting areas where muscle groups interconnect. The device comprising smooth soft nonviscous and breathable fabric like material with elasticity to cause compression against the body of the animal when worn. The device in general is preferably smooth in texture to avoid surface injury to the animal. The level of compression should be mild and comfortable, slightly compressing muscles against each other but not otherwise restrictive to movement or circulation. The intention of the compression affect in this case is to bring interconnected muscle groups closer together to improve contact between adjacent muscles among localized regions.

This helps drive muscle created stimuli among local muscle spindle cells for improved proportional tone development. The goal and purpose is to enhance inter-muscular stimulation reflective of the animal's own movement such that its cellular response would be in proportion to the animal's own force demand and synchronous with its own pattern of movement.

The path of communication for purposes of this invention should follow the neuro-synaptic pathway of the particular equine. In most cases, particularly canines and equines, the path is lateral where interconnected skeletal muscle groups coordinate between the fore-end and hind-end through the mid-section. This invention facilitates the natural path of neuro-muscular interaction by contact and compression among muscle groups along the length of the animal. It is important that the path of neuro-physiological communication be between areas of desired improvement or emphasis. If the device passes through areas not otherwise needing enhanced communication or stimulus, the misdirection may cause unnatural frequency of stimulation in those areas, leading to injury and chronic postural problems. The development of new skeletal muscle will be in proportion to received stimuli among spindle cells as discussed by Cameron-Tucker such that muscle development will be in proportion to the animal's own activity. The device of this invention should be constructed with minimal to no protrusions or such extra components that would otherwise cause artificial stimulation or extraneous stimulus noise substantially beyond the animal's own physiological demand. The device is preferably smooth in texture to avoid injury from extensive rubbing. The level of compression is preferably mild and not so tight as to cause pain or ache to the compressed areas.

The position of straps of this invention follows the lateral line of inter-muscular connection. The core feature of this device comprising a closed loop elastic band intended to be worn laterally along the length of the quadruped anima. At least one or more elastic band is positioned cross sectionally over the top of the closed loop band, primarily for the purpose of holding the closed loop band in place during use and movement. A first top elastic band is positioned rearward of the closed loop band near the hind-quarter of the quadruped while a second top elastic band is positioned above the front quarter. A bottom elastic band is connected to the bottom side of the closed loop elastic band in cross-sectional manner and optionally loops upward around the top side of the closed loop elastic band in full circle around the mid-section of the quadruped when worn. The device when worn, exerts a mild compression against the mid-section of the quadruped animal by said bottom elastic band, causing a lifting affect in relation to its natural movement. Enhanced stimuli is brought through the mid-section by way of the bottom elastic band to improve muscle awareness and tonal development relative to fore-quarter and hind-quarter movement.

Tension of this device against key muscle points on the animal's body helps to improve neurosynaptic communication and activity around the compressed area. The degree of pressure can be varied to adjust for proper level of communication to less receptive muscle regions. When the fore quarter moves in the forward direction, the front quarter muscle groups pushes against the closed loop elastic band of this invention, causing the band to pull against the hind quarter muscles and lift against the mid-section of the animal. The animal feels the coordinated push, pull and lift against targeted portions of the body in synchronous pattern and relative force to its own natural movement. The elastic material further pulls in lifting manner against the lower belly portion of the horse when the lateral portions are stretched, causing the horse to round and lift the arch of its back in response to overall active movement. The horse lowers its neck in response to a neutral position for improved alignment and posture. The fluctuating shift of force and neuro-muscular stimuli experienced by the quadruped over a period of use will help to generate proportional amount of new cell development and improved ton e to meet its ongoing activity demands. By the strict design requirements of this invention, not to include extraneous attachments or hard protrusions compressible against the animal's body and being non-viscous, the quadruped animal is able to sense almost purely its own movement and force demands. The quadruped animal thus adjusts to its own movement and does not develop unnatural dependencies to the device. As such, the device of this invention may be worn without the user present and preferably, may be worn either with or without the rider seated. Independence, confidence and improved posture and muscle tone are facilitated by this device.

A further object of this invention is to provide a device that can be quickly, easily and intuitively attached to the entire body of a horse by a single person. One embodiment of the invention may include a webbed device that is to be worn over the animal for the specific type of training or therapy sought to achieve. Another embodiment of the invention may comprise solid band of smooth soft nonviscous elastic fabric material. The device should be easily and intuitively worn over the animal's body with minimal connecting pieces to shorten the time for attaching device to the animal. The device preferably should avoid solid components such as plastic or metal connections or protruding portions such as knots or kinks to avoid hard rubbing against the horse's body, otherwise causing extraneous noise stimulus and injury to the contact area. The device should preferably not comprise linked chain material so as to avoid trapping and ripping of hair between the linking portions.

The preferred embodiment of the invention herein is intended for all quadrupeds, and specifically here for equines and canines. The device comprising a series of interconnected elastic bands in closed loop fashion. The material composition of each elastic band portion having a preferred range of tensity for purposes of creating mild compression against the animal's body. In the preferred embodiment herein, elongation is approximately 110% of the original gauge length, +/−10%. Each elastic band portion of this invention further comprising smooth soft non-viscous elastic fabric material that is breathable such as spandex, cotton, nylon or polyester or combinations thereof. Each elastic band portion should be wide enough to cover multiple local muscle groups of each region. Each elastic band being no less than 2 inches wide and preferably for purposes of use on equine, between 4 to 8 inches wide. The device should not comprise rope or chain or bands having such narrow width (less than 2 inches) because compression by a narrow band will cause acute stimulation to narrow muscle groups and eventual chronic harm and injury. The material may, but preferably does not contain latex material for reasons of skin sensitivity.

The band may be a simple single elastic band with only one point of connection. It may additionally comprise multiple elastic bands with multiple points of connection creating simple to complex webbing for the desired pattern of enhanced neuro-muscular communication. The various elastic bands preferably connecting by hook and loop means (i.e. Velcro) and without protrusions compressible onto or against the animal's body. The location of compression will define the targeted areas of the body for proprioception training and muscle stimulation enhancement. The pattern of interconnected points further aiding in targeted posture adjustment in tandem with muscle coordination training and resistance exercise.

The training device and method of use provided herein does not exist in the art at this time. Current products within the market lack the embodiment and capability to encourage the type of training and development that is achievable with this invention. Other features, advantages, and object of the present invention will become more apparent and be more readily understood from the following detailed description, which should be read in conjunction with the accompanying drawings.

### BRIEF DESCRIPTION OF DRAWINGS

FIG. 1 A side perspective view of a preferred embodiment of the invention as provided herein.

FIG. 2 A front right perspective view of the preferred embodiment of the invention as provided herein.

FIG. 3 A front left perspective view of the preferred embodiment of the invention as provided herein.

FIG. 4 A rear side plan perspective view of the preferred embodiment of the invention as provided herein.

FIG. 5 A front side plan perspective view of the preferred embodiment of the invention as provided herein.

FIG. 6 A right side plan view of the preferred embodiment of the invention as provided herein.

FIG. 7 A left side plan view of the preferred embodiment of the invention as provided herein.

FIG. 8 A top forward plan view of the preferred embodiment of the invention as provided herein.

FIG. 9 A top rear plan view of the preferred embodiment of the invention as provided herein.

### DETAILED DESCRIPTION

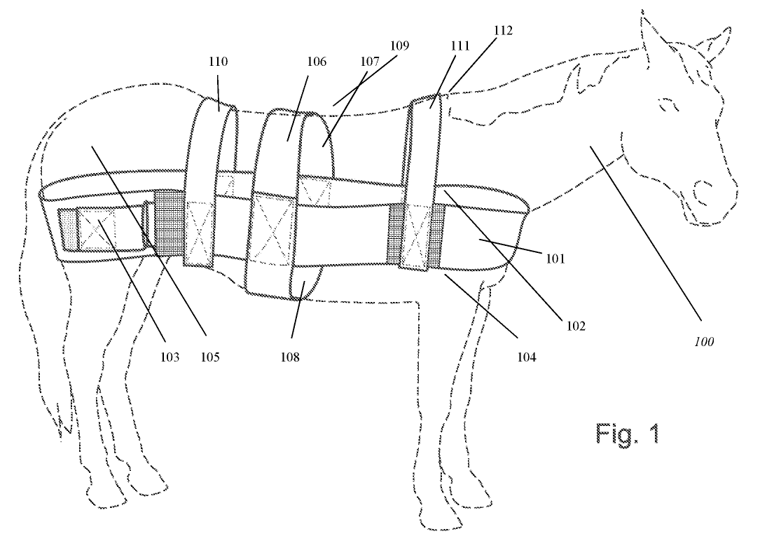

A preferred embodiment of the invention 100 herein being specifically geared for equine and canine use. In regards to equine use, the closed loop elastic band when worn should have an extended length ranging from 14.2 hands to 16.2 hands. The elements of this invention 100 being adjustable to achieve the same or similar effect for various sized animals, comprising a first closed loop elastic band 101 of a given length connected to create a closed loop elastic band, as provided in FIG. 1, having a tensity of 110% beyond its original gauge length when worn. Said closed loop elastic band 101 is preferably 10 inches wide but no less than 2 inches wide. The circumference of said closed loop elastic band 101 should be such that when worn, it completely encircles the lateral length of the quadruped animal with 110% elongation from its original gauge length, give or take an additional difference of 10% from its original gauge length. The closed loop elastic band 101 intended to be wrapped along the lateral length of an equine 100 between a front end 102 immediately above the pectorals, below the neck, and encircling the mid body and encompassing the mid buttocks. The band has a minimal tension against the animal's body when worn with a mild compression against the area of contact. Gauge tension may be tightened or loosened at different location on this device to achieve the particular therapy objective. According to the embodiment of FIG. 1, means for adjusting the overall circumference of the closed loop elastic band 103 may be located at either or both right 201 and left rear sides 202 of the device, but may be located anywhere along the length and circumference of the band. Said adjustment means 201, 202 may comprising any known means that otherwise does not contain hard material or any protrusions otherwise compressible against the animal's body to cause chronic injury from localized rubbing. The closed loop elastic band may comprise any known smooth soft nonviscous elastic fabric material, preferably of a breathable fabric-like texture and composition. Ideally, the material should not catch on the animal's skin or hair to avoid injury from excessive rubbing. The material further having a preferred tensile strength for purposes of maintaining long term elastic strength from multiple reuse as well as to provide the desired level of resistance training. When in use, the closed loop elastic band 101 stretches between the animal's front portion 104 and hind portion 105 in a parallel horizontal or lateral manner relative to the animal's body. The elastic pressure laterally against the animal's body creates a heightened sense of awareness to the coordination of movement between these two more disparate sections of the body through its midsection.

A second elastic band 203, 106, also referred to as the bottom elastic band, is located in the vertical position at a cross section around the bottom side of said closed loop elastic band and optionally looping full circle around the midsection of the quadruped animal over the arch of its back. When worn, the bottom elastic band wraps around the bottom midsection 107 or abdomen of the quadruped animal. The bottom elastic band 203, 106 is intended to encourage proper spinal posture and arch 109 in the equine animal by causing a lifting pressure against the abdominal area of the midsection. The bottom elastic band 203, 106 is preferably six inches wide and should be no less than 2 inches wide. Said bottom elastic band 203, 106 should be long enough to extend around the bottom girth of the quadruped animal 107, 108 with 110% extension beyond its original gauge length when worn. The bottom elastic band 201, 109 is attached to the closed loop elastic band 101 by a connection means located near the lower midsection area 108 of the animal's body. The fluctuating compression against the animal's body during movement between the forequarter, midsection, and hindquarter by the closed loop elastic band 101 and bottom elastic band 203 creates a synchronous pattern of stimulation during movement that helps to improve muscle tone, gate and posture. By causing a lift to the spine, space is increased in the vertebrae column, which helps alleviate central neurological symptoms. Spinal alignment further helps lower the neck to a more neutral balanced position.

An alternative embodiment having the same components as the preferred embodiment described above, further comprising a first 111 and second top elastic band 110 connected to the top side of said closed loop elastic band. When worn, said first and second top elastic bands being in contact with the upper front shoulder 104 (resting over the animal's lower neck region) and upper hindquarter 105 of the quadruped animal, as provided in FIG. 1. The first and second top elastic bands 111 are detachably connectable to the closed loop elastic band 101 at either it's left or right sides or both sides. See FIG. 1. Either first and second top elastic band 111 being no less than four inches in width but no less than 2 inches in width. Said first and second top elastic band having a length sufficient to wrap around the top side of the quadruped animal (at the respective front quarter and hind quarter 105) with 110% elongation from its original gauge length and with an additional 10% extension or compression length beyond the 110% stretch capability. The purpose of the first 111 and second 110 top elastic band is primarily to hold the closed loop elastic band and bottom elastic band in place on the horse's body during use. The respective lengths (or tensile) of each said first 111 and second 110 top elastic bands may be adjusted at their respective location of connection by their connection means. The connection means in this case also preferably a hook and loop device (i.e. Velcro), not containing hard material or protrusions otherwise compressible against the animal's body to cause chronic local injury. The first and second elastic band is comprised of the same type of material as that of the closed loop elastic band and the bottom elastic band.

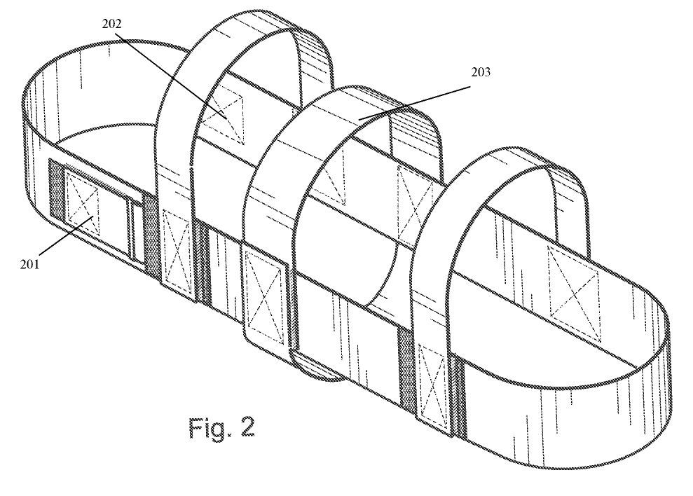

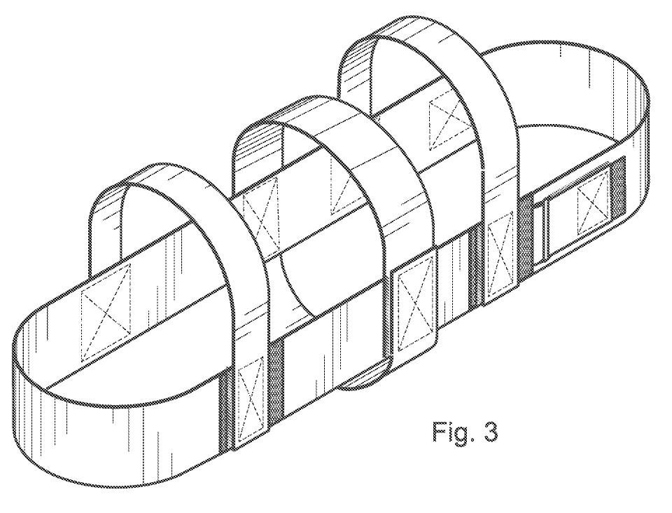

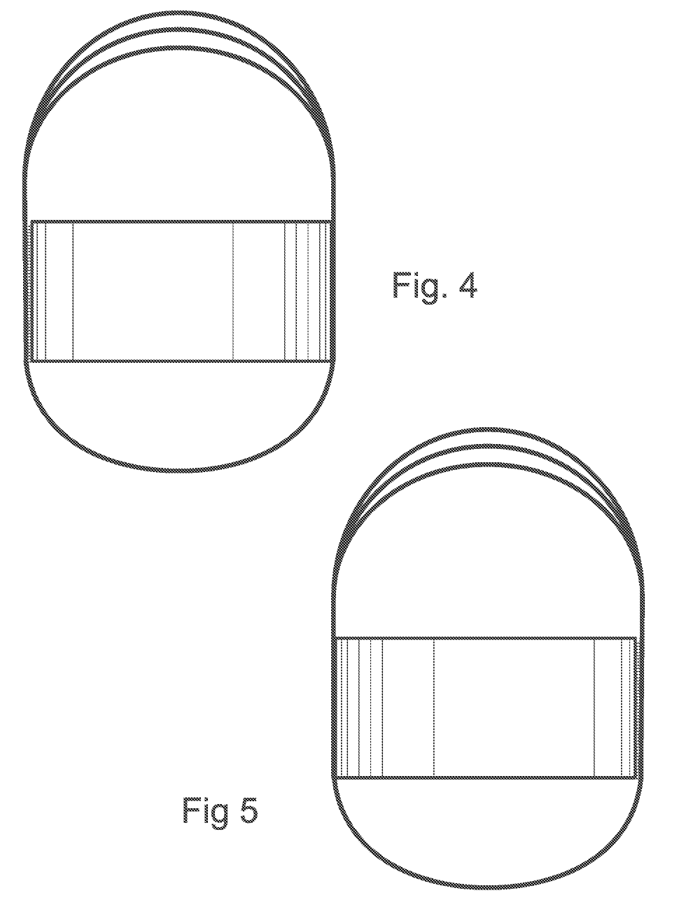

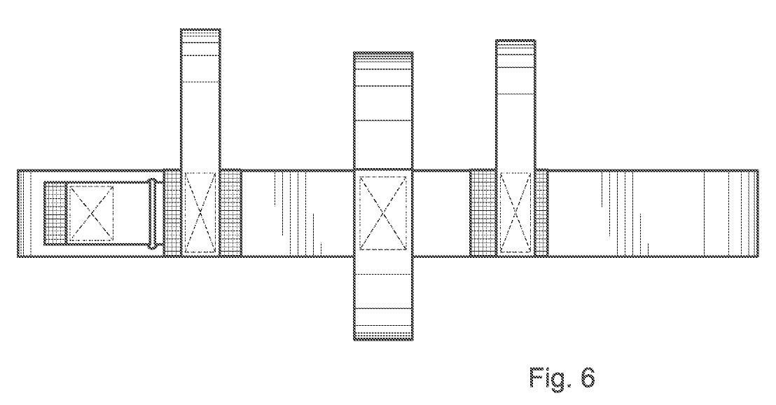

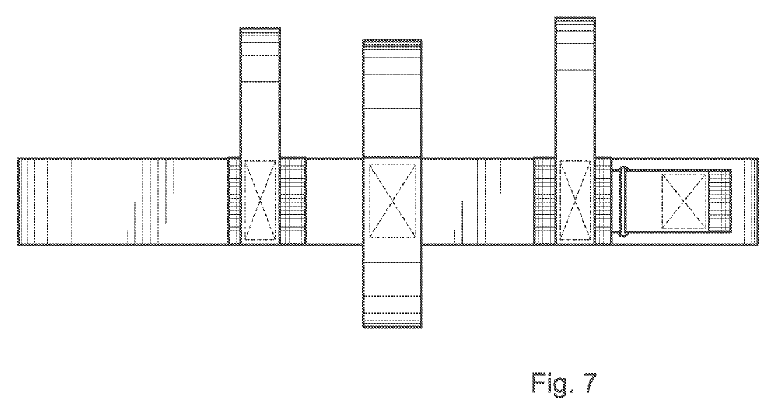

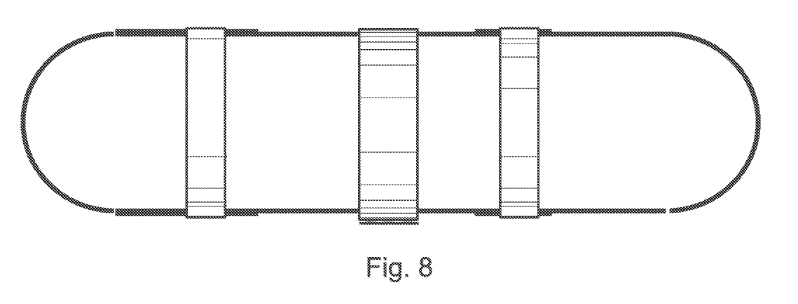

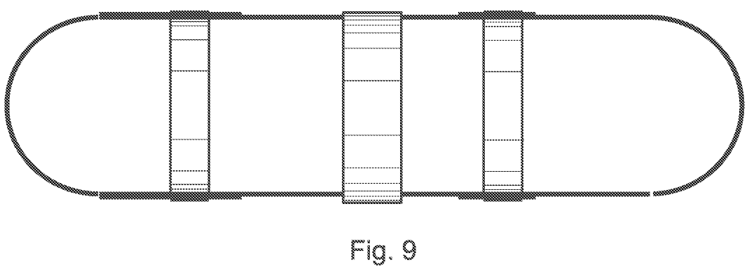

The preferred embodiment of FIGS. 2, 3 6, 7, 8 and 9 provides for lateral adjustments to the rear on both sides of the device and attachment points for the vertical bands on the right side of the device, as worn by the animal. FIGS. 4 and 5 provide a plan view of the device from rear and front sides, respectively. Alternative methods of design accomplishing this same effect would be considered inherent to this invention. The device overall and in general should not have any protrusion or attachment that compresses into the skeletal muscle of the quadruped animal. The device is preferably flat in nature and attachable between its various parts by hook and loop means. The device should not create additional artificial pressure or stimulus upon the area of contact beyond the natural compression and force exerted by the quadruped animal's own movement upon and through the device worn. The device therefore should not contain hard material attachments that can protrude or compress onto the skeletal muscle of the quadruped animal.

The overall benefit and effect of this tool is multifaceted. Benefits include but are not limited to the following: 1) enhanced skeletal muscle and tone development in response to activity demands, 2) improved neuro-physiological awareness and communication between distal regions of the body, 3) improved inter-muscular coordination, 4) improved posture and gate, 5) improved independence and confidence, 5) means for diagnosing areas of weakness and muscle isolation.

Having fully described at least one embodiment of the present invention, other equivalent or alternative methods according to the present invention will be apparent to those skilled in the art. The invention has been described by way of summary, detailed description and illustration. The specific embodiments disclosed in the above drawings are not intended to be limiting. Implementations of the present invention with various different configurations are contemplated as within the scope of the present invention. The invention is thus to cover all modifications, equivalents, and alternatives falling within the spirit and scope of the following claims.

I claim:

1: A rehabilitation device for a quadruped animal comprising:
a closed loop elastic band wearable laterally around a quadruped animal, surrounding the front chest, the mid-section and the rear portion of said quadruped animal in straight lateral path,
said closed loop elastic band comprising smooth soft nonviscous elastic fabric material extendable by 10% to 20% of its original gauge length,
said closed loop elastic band being no less than two inches wide,
said closed loop elastic band having a circumference that when worn around the lateral body of a quadruped animal is extended 10% to 20% beyond its original gauge length,
said rehabilitation device for a quadruped animal having no hard material attachment or protrusion inwardly compressible against the body of said quadruped animal,
said rehabilitation device for a quadruped animal not comprising braided rope or linked chain.

2: Said rehabilitation device for a quadruped animal according to claim 1 further comprising
a bottom elastic band detachably connectable in cross sectional manner across the bottom side of said closed loop elastic band such that said bottom elastic band wraps around the midsection of said quadruped when worn,
said bottom elastic band comprising smooth soft breathable nonviscous elastic fabric material that is extendable by 10% to 20% beyond its original gauge length,
said bottom elastic band having a length that when worn around the bottom mid-section of a quadruped animal is extended 10% to 20% beyond its original gauge length,
said bottom elastic strap being no less than two inches wide,
said bottom elastic band band not comprising braided rope or linked chain,
said bottom elastic band and means for detachably connecting said bottom elastic band to said closed loop band having no hard material attachment or protrusion inwardly compressible against the body of said quadruped animal.

3: Said rehabilitation device for a quadruped animal according to claim 1 further comprising
one or more top elastic band detachably connectable in cross sectional manner at the top side of said closed loop elastic band such that said one or more top elastic band wraps across the back of said quadruped to maintain said closed loop elastic band laterally in position when worn by said quadruped,
said one or more top elastic band comprising smooth soft breathable nonviscous elastic fabric material that is extendable by 10% to 20% beyond its original gauge length,
each said one or more top elastic band having a length that when worn over the quadruped animal is extended 10% to 20% beyond its original gauge length,
said one or more top elastic band being no less than two inches wide.
said one or more top elastic band not comprising braided rope or linked chain,
each said one or more top elastic band and means for detachably connecting said one or more top elastic band to said closed loop band having no hard material attachment or protrusion inwardly compressible against the body of said quadruped animal.

5: Said rehabilitation device for a quadruped animal wherein each said one or more top elastic band and bottom elastic band are each detachably connectable to said closed loop elastic band by hook and loop means.

6: A rehabilitation device for a quadruped animal comprising:
a closed loop elastic band wearable laterally around a quadruped animal, surrounding the front chest, the mid-section and the rear portion of said quadruped animal in straight lateral path,
a bottom elastic band detachably connectable in cross sectional manner across the bottom side of said closed loop elastic band such that said bottom elastic band wraps around the midsection of said quadruped when worn,
one or more top elastic band detachably connectable in cross sectional manner to the top side of said closed loop elastic band such that said one or more top elastic band wraps across the back of said quadruped to maintain said closed loop elastic band laterally in position when worn by said quadruped,
said closed loop elastic band, bottom elastic band and said one or more top elastic band each comprising smooth soft breathable nonviscous elastic fabric material having an elasticity that is extendable by 10% to 20% beyond its original gauge length,
said closed loop elastic band, bottom elastic band and said one or more top elastic band each being no less than two inches wide,
said rehabilitation device for a quadruped animal having no protrusion inwardly compressible against the body of said quadruped animal.

7: Said rehabilitation device for a quadruped animal according to claim 6 comprising a first, second and third top elastic band, said first elastic band detachably connectable in cross sectional manner across the front top side of said closed loop elastic band, said second elastic band detachably connectable in cross sectional manner across the rear top side of said closed loop elastic band, said third top elastic band extending from said bottom elastic band and wrappable around the top central arch of said quadruped animal,
said first top elastic band positionable over the front quarter shoulder of said quadruped animal and said second top elastic band positionable over the rear hind quarter of said quadruped and said third top elastic band positionable over the top central arch of said quadruped animal when said device is worn by said quadruped animal,

8: A system and method for rehabilitating quadruped skeletal muscle tone and postural movement comprising:
a device according to claim 6,
wherein said device is worn by said quadruped such that said quadruped is wrapped between its front quarter, mid-section, hind quarter and abdomen in compressed manner,
said device having a compression strength against said animal such said device is extendable by 10% to 20% beyond than its original gauge length when worn by said animal,
said compression of said device against the skeletal muscles of said quadruped animal being non-restrictive of movement or blood flow when worn,
wherein said device is wearable by said quadruped with and without a rider or handler present,
wherein said quadruped animal adjusts to shifting compression force against its skeletal muscles between said closed loop elastic band, bottom elastic band and said one or more top elastic band in response to its own movements,
wherein said quadruped animal compensates in its postural coordination between its front quarter, mid-section, hind quarter and abdomen in response to shifting compression force against its skeletal muscles by and between said closed loop elastic band according to its own movement against said device.

9: A system and method for rehabilitating quadruped skeletal muscle tone and postural movement according to claim 8 wherein the length of each said closed loop elastic band, bottom elastic band and one or more top elastic band is separately adjustable such that tightening or loosening of each said length tightens or loosens compression against the skeletal muscle in contact with said adjusted portion and further tightens or loosens compression between said front quarter, mid-section, hind quarter and abdomen of said quadruped.
